(19) United States
(12) Patent Application Publication
(10) Pub. No.: US 2016/0208656 A1
(43) Pub. Date: Jul. 21, 2016

(54) OPERATING METHOD FOR AN EXTERNALLY HEATED FORCED-FLOW STEAM GENERATOR

(71) Applicant: SIEMENS AKTIENGESELLSCHAFT, München (DE)

(72) Inventors: Jan Brückner, Uttenreuth (DE); Frank Thomas, Erlangen (DE)

(73) Assignee: Siemens Aktiengesellschaft, Munich (DE)

(21) Appl. No.: 14/913,017

(22) PCT Filed: Aug. 20, 2014
(86) PCT No.: PCT/EP2014/067729

§ 371 Date: Feb. 19, 2016

(30) Foreign Application Priority Data
Aug. 28, 2013 (DE) 10 2013 217 167.6

(51) Int. Cl. F01K 7/16; F03G 6/06

(52) U.S. Cl. CPC F01K 7/165; F03G 6/06

(57) ABSTRACT

An operating method for an externally heated once-through steam generator, in particular a once-through steam generator is heated using solar thermal energy and has a steam turbine connected downstream of the once-through steam generator. A pressure regulation device, having at least one turbine valve for regulating the pressure, is arranged in the feed water-steam circuit between the once-through steam generator and the steam turbine, the pressure regulation device being controlled by a control unit in such a way that, in the event of sudden load reductions, the drop in pressure associated therewith occurs, in a time delayed manner, by throttling of the at least one turbine valve.

### CROSS REFERENCE TO RELATED APPLICATIONS

This application is the US National Stage of International Application No. PCT/EP2014/067729 filed Aug. 20, 2014, and claims the benefit thereof. The International Application claims the benefit of German Application No. DE 102013217167.6 filed Aug. 28, 2013. All of the applications are incorporated by reference herein in their entirety.

### FIELD OF INVENTION

The invention relates to an operating method for an externally heated forced-flow steam generator, in particular a forced-flow steam generator that is heated by way of solar thermal energy.

### BACKGROUND OF INVENTION

Solar thermal power plants represent an alternative to conventional electricity generation. A power plant concept that is already known in this sector is the so-called parabolic trough power plant. In this power plant type, thermal oil is typically used as heat carrier medium, which thermal oil flows through the parabolic troughs of a solar array and thus absorbs the heat introduced by way of the sun as an external heat source and transmits said heat to a flow medium flowing through the steam generator.

For such a steam generator that is heated by solar thermal energy, the forced-flow principle represents a particular embodiment. The flow medium entering the forced-flow steam generator, said flow medium also being referred to here as feedwater, is warmed up, evaporated and superheated in one pass. The superheated flow medium is then supplied as fresh steam to the steam turbine via a water-steam separator. Here, the water-steam separator at the outlet of the forced-flow steam generator is used predominantly during the start-up phase. By contrast, during the normal load operation phase, it is necessary for sufficient superheated flow medium to always be present at the outlet of the forced-flow steam generator, and thus also in the water-steam separator, in order that the steam turbine is not impinged on with saturated steam. The setting of the corresponding fresh steam temperature at the outlet of the forced-flow steam generator can therefore be precisely set only through the selection of the correct feedwater mass flow, or fluctuations in the feedwater mass flow are linked directly to fluctuations in the fresh steam temperature.

To counteract such fluctuations of the fresh steam temperature in the feedwater-steam circuit, in particular during the load operation phase of solar thermal power plants, a method for the predictive regulation of the feedwater mass flow by way of a corrective value has already been proposed in WO 2012/110344 A1. This type of predictive regulation of the feedwater mass flow makes it possible for deviations of the specific enthalpy prevailing at the outlet of the forced-flow steam generator from the setpoint value, and resulting undesirably large fluctuations of the fresh-steam temperature in all operating states of the load operation phase, such as are caused by transient states for example in the event of a change in load, to be kept as small as possible.

It has now been found that, in the event of rapid decreases in load in the load operation phase, specifically in the lower load range, where low pressures prevail, it may be the case, in the water-steam circuit of the flow medium, that inadmissibly large temperature fluctuations of the fresh steam that arises at the outlet of the forced-flow steam generator occur. For example, in the case of solar thermal power plants, if, owing to reduced heat absorption as a result of fluctuating solar radiation, the mass flow of the flow medium through the forced-flow steam generator is also reduced, and if this additionally takes place at low pressures at which the relatively great differences in physical characteristics of water and steam have a correspondingly more severe effect, it may be the case that said temperature fluctuations can no longer be fully intercepted by way of the feedwater regulation concept described in WO 2012/110344 A1. Since it is the case here, in the event of a rapid decrease in load, that the pressures drop too rapidly and to too great an extent in accordance with the natural sliding pressure characteristic, a disproportionately high fresh steam mass flow in relation to the quasi-steady state prevails at the outlet of the forced-flow steam generator. If, in the event of a decrease in load, the pressure falls, then in the case of rapid decreases in load in the lower load range, an excessive amount of steam is released from the forced-flow steam generator, resulting in a relatively intense decrease in the fresh-steam temperature. Such temperature fluctuations may then, depending on magnitude, lead to an undesired shutdown of the steam turbine connected downstream of the forced-flow steam generator, and thus to a shutdown of the power plant as a whole.

### SUMMARY OF INVENTION

Therefore, for power plants, and in particular for power plants operated using solar thermal energy, in which, by contrast to power plants with thermal storage means, the rate of change of load cannot be freely selected but is dependent on the respective solar radiation, it is the object of the invention to provide an operating method for an externally heated forced-flow steam generator, with the aid of which method such inadmissibly high and thus possibly no longer controllable temperature fluctuations at the outlet of the forced-flow steam generator, which is externally heated by solar thermal energy or from some other source, can be prevented even during rapid decreases in load in the lower load range.

This is achieved, with the operating method for an externally heated forced-flow steam generator, in particular a forced-flow steam generator that is heated by way of solar thermal energy, by means of the features of the independent claim.

By virtue of the fact that, during a rapid decrease in load caused by an external heat source (such as for example the sun), the associated drop in fresh-steam pressure takes place in time-delayed fashion by way of throttling of the at least one turbine valve, which thus gives rise to a modified sliding pressure characteristic that deviates from the natural sliding pressure, it is possible even for rapid decreases in load, specifically in the lower load range of the load operation phase, for the fresh-steam temperature at the outlet of the forced-flow steam generator to be kept within admissible limits. In this way, an undesired shutdown of the steam turbine connected downstream of the forced-flow steam generator can be avoided, and thus the availability of the power plant, in particular of the solar thermal power plant, can be permanently ensured. Thus, the method according to the invention can additionally stabilize the pressure regulation as a whole, and can furthermore support the feedwater regulation concept described in the WO 2012/110344 A1 with regard to regulation of the fresh-steam temperature with little fluctuation, because the pressure exhibits reduced transients during the load reduction and thus also when the fixed-pressure setpoint value is reached, and thus yields reduced undershoots and overshoots in relation to the fixed-pressure setpoint value.

This can be achieved particularly advantageously by way of power control of the steam turbine in a manner optimized for the usage situation. It has been found that a highly effective method of moderately lowering the pressure consists in the present power delivery of the steam turbine being functionally coupled to the heat flow presently being transmitted from the heat carrier medium to the forced-flow steam generator. Specifically, this means that, considered relatively, the steam turbine must reduce its load at exactly the same rate as the heat presently being transmitted to the forced-flow steam generator decreases.

Since the steam production of a forced-flow steam generator that is heated by way of solar thermal energy always, owing to its both thermal and volumetric storage capacity, follows the present heat output by the heat carrier medium with a time delay, it is possible, in the event of a decrease in load, for the demand for equal rates of change of heat release of the heat carrier fluid and power delivery of the steam turbine to be achieved by throttling of the turbine valves. For this purpose, the pressure regulator that actuates the at least one steam turbine valve must be suitably augmented. If a power setpoint value for the steam turbine is formed on the basis of the heat flow presently being transmitted to the steam generator, and said power setpoint value is compared with the present power delivery of the steam turbine, it is possible, after corresponding normalization, for the regulation deviation formed therefrom to be directly used for suitably actuating, by way of the regulator used in the pressure regulation, the steam turbine valves with regard to the power delivery of the steam turbine.

For this purpose, the heat power presently being transmitted to the forced-flow steam generator by the heat carrier medium must be determined. If said determination is performed for example in accordance with the feedwater regulation concept known from WO 2012/110344 A1, this can be used directly, without additional outlay, for forming the power setpoint value of the steam turbine.

If such pressure regulation modified in accordance with the invention is now used, only a moderate decrease in pressure occurs after a rapid decrease in load. Since said pressure regulation is self-intensifying, it is the case, with regard to the rate of change of the load, that the pressure reduction is all the more moderate the faster the load decreases. By contrast, the regulation according to the invention does not intervene in a subsequent increase in load, because here, the forced-flow steam generator lags behind the heat flow output by the heat carrier medium. Specifically, this means that no additional throttling of the at least one turbine valve takes place during an increase in load, and thus the turbine valves are opened at the earliest possible point in time and ensure maximum possible power delivery of the steam turbine, which is desired here.

A major advantage of this modified pressure regulation consists in that, in parallel with the known pressure regulation, it is now possible for the power delivery of the steam turbine to also be suitably influenced. Here, the regulation concept according to the invention can operate permanently, and does not need to be activated for the first time by way of suitable criteria during a decrease in load and subsequently deactivated again for an increase in load. Thus, no additional outlay is required for the method according to the invention, because the adaptations can be incorporated into pressure regulation structures such as are conventional nowadays, and the measurement and data values required for this are already substantially available.

Here, the method according to the invention can basically be used for all externally heated forced-flow steam generators regardless of the heat carrier medium. However, specifically in the case of forced-flow steam generators that are heated by way of solar thermal energy, and which are temporally highly dependent on fluctuations in solar radiation, it is the case in the event of a decrease in load that the delivered turbine power, and the behavior thereof with respect to time, are coupled more closely to the power characteristics of the solar array by way of the method according to the invention, which may be advantageous with regard to the regulation of the power plant as a whole.

Optionally, in the presence of multiple steam turbine valves, it specifically normally being the case that, in plants with intermediate superheating, a low-pressure turbine valve is also provided in addition to the high-pressure turbine valve, the method could also be applied to the different turbine valves. Under these circumstances, it would also be possible for the intermediate superheater, at the heat carrier medium side, and/or the low-pressure turbine, at the turbine side, to be incorporated into the pressure regulation.

### BRIEF DESCRIPTION OF THE DRAWINGS

The invention will now be discussed in more detail by way of an example and on the basis of the following figures, in which:

FIG. 1 schematically shows a known pressure regulation configuration, and

FIG. 2 schematically shows a refinement according to the invention.

### DETAILED DESCRIPTION OF INVENTION

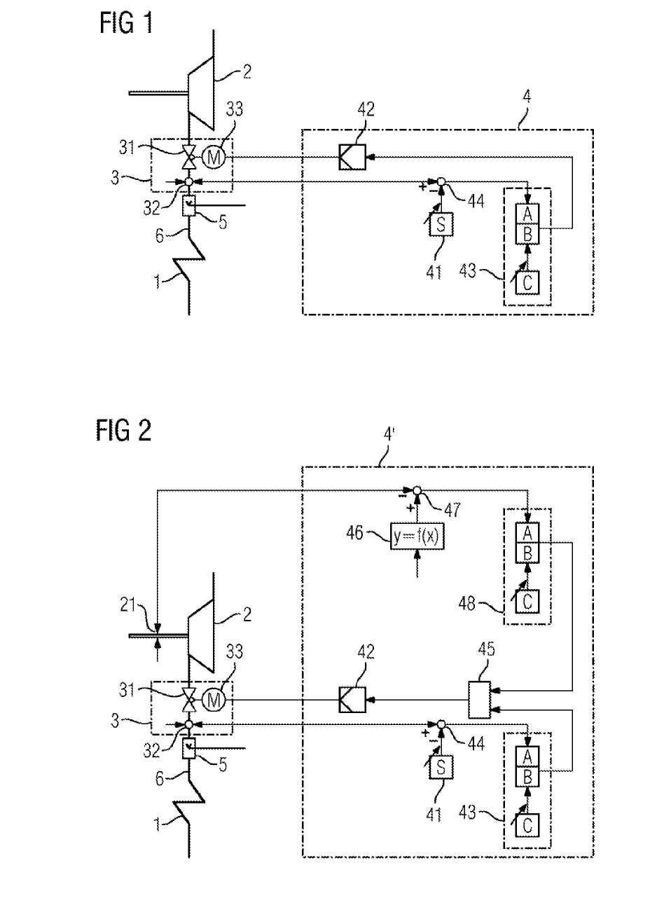

FIG. 1 shows, in highly schematic form, a conventional pressure regulating device 3 arranged between a forced-flow steam generator 1 and steam turbine 2. Said pressure regulating device 3 is in this case composed of an adjustable regulating valve 31 and of a pressure measurement device 32 in the steam line 6 between forced-flow steam generator 1 and steam turbine 2. By way of the pressure measurement device 32, the fresh-steam pressure prevailing in the steam line 6 is measured and fed to a regulation device 4. The presently prevailing pressure setpoint value 41, which normally corresponds to the fixed pressure, is subtracted from the measured fresh-steam pressure. The regulation deviation 44 thus obtained is, after corresponding normalization 43, fed to a regulator 42. Said regulator 42 may for example be a PID, PI or P regulator or a combination of the individual regulators. Then, in accordance with the regulation deviation, the regulator 42 actuates the regulable valve 31, by way of a motor 33 or else any other control element, such that the predefined pressure setpoint value can be sustainedly set. Here, it is conventionally the case, during normal load operation, that the turbine valve is fully opened and the pressure varies in accordance with the natural sliding pressure characteristic in the event of changes in load. Only if, in the event of a correspondingly large decrease in load, the present fresh-steam pressure falls below the fixed-pressure setpoint value does the regulation begin to intervene and close the turbine valve such that the predefined pressure setpoint value (fixed pressure) is set.

As has now been found, it is the case in regulating devices of said type that the manner in which the pressure is managed during load reductions, specifically in the lower load range, plays a key role with regard to intense temperature fluctuations at the forced-flow steam generator outlet. In the event of a rapid decrease in load (>5%/min) in the lower load range, if the pressures fall too rapidly and to too great an extent in accordance with the natural sliding pressure characteristic, giving rise to large pressure transients, then a disproportionately high fresh-steam mass flow prevails at the outlet of the forced-flow steam generator in relation to the quasi-steady state. This is because, owing to the decrease in pressure in the feedwater-steam circuit, additional flow medium evaporates in the forced-flow steam generator. The additional steam requires a relatively larger volume in the steam generator pipes, and thus, owing to its expansion, forces a greater throughput at the outlet of the forced-flow steam generator in relation to the water phase, which the now additionally produced steam was still in a short time previously. This effect is increasingly intensified for decreasing pressures, because here, the differences in density between the water phase and steam phase continuously increase. Accordingly, if, in the event of a decrease in load, the pressure falls, then for the stated physical reasons, in the event of rapid decreases in load in the lower load range, an excessive amount of steam is released from the forced-flow steam generator. This results firstly in a relatively intense decrease in the fresh-steam temperature, because additional energy is required for the additional steam production, and secondly in a temporary evacuation of the volume of the steam generator heating surface. Owing to the large heating surface volume of such steam generators, a feedwater regulator that is provided can, in particular in the lower load range in which the feedwater mass flow is very low, refill the virtually evacuated steam generator pipes only with a delay. This results firstly in an intense increase in temperature at the outlet of the forced-flow steam generator. Owing to the temporally preceding release effects at the flow medium side during the rapid decrease in pressure during the load decrease, and the resulting reduced flow medium content, relatively less steam, which however now has increased final temperatures, and thus more intense final superheating, can be generated over the further course of time. This negative side effect can be compensated by way of an injection cooling apparatus 5, such that there is no risk of adverse effects on the process. Depending on the extent of the evacuation, however, secondly, more or less intense decoupling between feedwater mass flow and fresh-steam mass flow occurs. Specifically, this means that, proceeding from this point in time, the feedwater regulation can no longer satisfactorily react to subsequent temperature fluctuations resulting for example from changes in load. This is further exacerbated in that, in the case of said decoupling, the evaporation end point may be displaced very far upstream with regard to the flow medium, into the forced-flow steam generator, and, under these circumstances, the steam generator pipe length with superheated flow medium is greatly lengthened. As a consequence, it is then the case at the heat carrier medium side in the inlet region of the forced-flow steam generator that the heat carrier medium is at a much higher temperature than during the steady state that prevails during the load operation phase. Since it is the case here that the heat carrier medium also acts as storage medium, it then takes a very long time in the subsequent load operation phase, in particular in the presence of low feedwater mass flows, for said additionally stored energy to be released again. Under these circumstances, the steam temperature remains at a high temperature level for a very long time. The corrective regulator, installed in the feedwater regulation concept, for the fresh-steam temperature will excessively increase the feedwater mass flow during this long time period, because the regulation will attempt to lower the temperature, which has risen in relation to the setpoint value, as quickly as possible, with the result that, at some point, the fresh-steam temperature will inevitably collapse. This temperature decrease is a result of the increased feed, and then cannot be intercepted even by the injection cooling apparatus 5, such that, in the event of a minimum steam temperature being undershot, the steam temperature must cease operation for its own protection. This considerably impairs the availability of the plant as a whole.

It is precisely this that is the starting point for the present invention. By virtue of the fact that the pressure follows a modified sliding-pressure characteristic that deviates from the natural sliding pressure, and thus the pressure decrease during the change in load is more moderate, the additional steam production with respect to time is reduced. An evacuation of the forced-flow steam generator, with all of its consequences, can be effectively counteracted by virtue of the additional steam production caused by the pressure decrease being lengthened, and thus the feedwater and fresh-steam mass flows being kept more in equilibrium with respect to one another.

According to the invention, as illustrated in FIG. 2, a modified regulation device 4′ is therefore provided. This comprises, in addition to the regulation loop 41 to 44 illustrated in FIG. 1, a further regulation loop by means of which the present power delivery of the steam turbine can be regulated in accordance with a predefined power setpoint value. For this purpose, in the additional regulation loop, the power setpoint value 46, which can be determined in the form of a mathematical function on the basis of the heat power introduced into the steam generator, is subtracted from a steam turbine power presently measured by way of a corresponding measurement device 21. The regulation deviation 47 thus formed is likewise fed, after corresponding normalization 48, to the regulator 42 in order to thus then correspondingly set the demanded power of the steam turbine. Since, in the present exemplary embodiment in FIG. 2, in addition to the power regulation, it is also sought to react to deviations with respect to a predefined pressure setpoint value, a minimum selection 45 has the effect that always the greatest regulation deviation with negative sign is used, which ensures a corresponding closure of the regulating valves. Depending on the regulation deviation of the individual regulating loops, it is thus either the power regulation of the steam turbine or the pressure regulation that performs the control of the throttling behavior of the single regulating valve 31 shown in FIG. 2. In the simplest case, in which merely the fixed pressure is predefined as a constant value as a pressure setpoint value, it is the case in the event of a decrease in load that the regulating loop 46-48 (power regulation of the steam turbine) performs the control until the present turbine inlet pressure falls below the predefined fixed-pressure level. Proceeding from this point in time, the regulating loop 41 to 44 performs the control and thus ensures that the fixed-pressure setpoint value can be ensured by way of further throttling of the regulating valves.

Specifically, the moderate decrease of the pressure consists in coupling the power delivery of the steam turbine to the release of heat by the heat carrier medium to the forced-flow steam generator. Thus, in the normal situation, during a decrease in load with turbine valves simultaneously fully open, it is the case owing to the release effects of the forced-flow steam generator, as mentioned in the introduction, that the turbine power temporarily remains at a higher level in relation to the heat absorption of the forced-flow steam generator (after the load change comes to an end, equilibrium is assumed again between absorbed heat and released turbine power). Now, if, in the case of the same decrease in load, the power that is coupled out of the steam turbine is throttled so as to be consistent with the heat power absorbed by the forced-flow steam generator (this is achieved by partially closing the turbine valve), more fluid thus temporarily remains in the forced-flow steam generator. As a result, the pressure in the forced-flow steam generator falls relatively more slowly, and an undesired evacuation of the forced-flow steam generator does not occur, or occurs only to a reduced extent. In this way, the fresh-steam temperature at the outlet of a forced-flow steam generator that is heated by solar thermal energy remains regulable by way of the feedwater regulation described in the WO 2012/110344 A1 even in the event of rapid decreases in load in the lower load range.

1. An operating method for an externally heated forced-flow steam generator having a steam turbine connected downstream of the forced-flow steam generator, wherein, in the feedwater-steam circuit between the forced-flow steam generator and steam turbine, there is provided a pressure regulating apparatus having at least one turbine valve for regulating the pressure, the method comprising:
actuating the pressure regulating apparatus by a control device such that, in the event of sudden decreases in load, the associated drop in pressure takes place in time-delayed fashion by way of throttling of the at least one turbine valve.

2. The operating method as claimed in claim 1,
wherein the modified sliding pressure characteristic is configured for optimized power control of the steam turbine.

3. The operating method as claimed in claim 2, further comprising:
for the optimized power control of the steam turbine, forming a power setpoint value for the steam turbine on the basis of a heat flow presently being transmitted to the forced-flow steam generator, and
comparing said power setpoint value with a present power delivery of the steam turbine.

4. The operating method as claimed in claim 1,
wherein the externally heated forced-flow steam generator comprises a forced-flow steam generator that is heated by way of solar thermal energy.
